(19) United States
(12) Patent Application Publication
(10) Pub. No.: US 2007/0102992 A1
(43) Pub. Date: May 10, 2007

(54) Rim, and method for manufacturing a rim

(75) Inventor: Gerrit Jager, Pery (CH)

Correspondence Address: GREER, BURNS & CRAIN, 300 S WACKER DR, 25TH FLOOR, CHICAGO, IL, 60606, US

(73) Assignee: DT SWISS INC.

(21) Appl. No.: 11/593,349

(22) Filed: Nov. 6, 2006

(30) Foreign Application Priority Data
Nov. 9, 2005 (DE) 10 2005 053 799.5

(51) Int. Cl. B60B 21/02

(52) U.S. Cl. 301/30

(57) ABSTRACT

A bicycle rim and a method for manufacturing a bicycle rim which bicycle rim includes a rim body which includes at least a rim base and brake sidewalls. The rim body consists at least in part of a fibrous composite material and the brake sidewalls include a brake layer of a friction-enhancing material.

### BACKGROUND

The invention relates to a rim and a method for manufacturing a rim, and a wheel. Although the invention will be described below with respect to a rim for a bicycle, the invention may be employed with other unicycles or multi-cycles, such as in particular bicycle trailers or wheelchairs.

For bicycles in the professional and semi-professional field but also in the field of serious recreational cyclists the weight and stress tolerance of the bicycle components play a decisive role.

To meet these requirements, bicycle rims of different materials have become known in the prior art. To reduce the weight, manufacturers of high-quality bicycle rims therefore use not steel, but in particular aluminum alloys and increasingly also fiber-reinforced plastic.

Such fiber-reinforced plastic comprises a matrix and reinforcing fibers embedded therein. Said matrix confers to the fibrous composite material the shape which can be designed as required. The matrix also determines to a considerable extent through the composition of its material the friction between the brake sidewall and the brake shoes of the rim brake. A high friction coefficient allows a high braking deceleration. Another requirement is high durability and a highly equal braking deceleration, weather conditions notwithstanding.

It is therefore the object of the present invention to provide a bicycle rim which allows good braking properties in different weather conditions.

### SUMMARY

The bicycle rim according to the invention comprises a rim body which includes at least a rim base and brake sidewalls. The rim body consists at least in part of a fibrous composite material and the brake sidewalls comprise a brake layer of a friction-enhancing material.

The invention offers considerable advantages. The invention allows to employ lightweight and extremely lightweight materials in the field of bicycles while a high braking deceleration can be achieved with rim brakes which achieve satisfactory braking deceleration values in different weather conditions. Durability is furthermore increased since the fibrous composite material is not easily stressed and rubbed off. Friction is absorbed in the brake layer which consists of a much harder material.

The rim body consists in particular not only partially but substantially entirely of a fibrous composite material. Also, a rim body is conceivable consisting partially of metal, in particular an aluminum alloy, and partially of a fibrous composite material. The brake layer is in particular provided on the surface of the brake sidewalls which consist of a fibrous composite material. The brake layer may contain some thickness.

In preferred embodiments the rim body consists at least in part of a fibrous composite material with a thermoplastic matrix. In particular the rim body consists entirely or substantially entirely of a fibrous composite material with a thermoplastic matrix material.

This offers considerable advantages. It is not necessary to deep-freeze thermoplastic matrix materials before use since the materials keep indefinitely even at room temperatures. Even a power failure and thus cooling failure cannot cause the raw material to clump together. The material is dry and not sticky which is an advantage in handling. Moreover, no vapors hazardous to human health can escape during storage and forming.

Another advantage is the break behavior of thermoplastic bicycle components. Unlike thermosetting components, thermoplastic bicycle components do not break abruptly and practically they do not splinter. Moreover such materials can be welded and machined better. It is another advantage of thermoplastic materials that application of heat may have a self-healing effect on defects. It is another advantage of the rims according to the invention that defects of thermoplastic elements can be repaired by thermal treatment.

Moreover very short manufacturing times are possible since the matrix materials only need to be liquified in the furnace for the matrix to form. Thereafter the mold may be cooled. There is no need for a reaction time of two hours or more. A few minutes are sufficient.

This allows to manufacture a much larger number of components per unit time with one mold since manufacturing time from start of placing until the following placing is reduced from more than two hours to e.g. 30 minutes or less. This means a manufacturing rate increased by a factor of four with one mold. Thus the manufacturing costs per piece are considerably reduced.

The rim may comprise in addition to the fibrous composite material, metal components e.g. metal rim eyelets may be provided.

Preferred specific embodiments provide for the brake layer to contain particles of the friction-enhancing material. In particular the brake layer substantially consists of a carrier material in which the particles of the friction-enhancing material are received or embedded. Or else, the brake layer may substantially consist of the friction-enhancing material.

Preferred specific embodiments of the bicycle rim provide for the friction-enhancing material to comprise a ceramic material. Ceramic materials are most suitable since they are very hard and durable and eliminate the generated heat excellently. Typical particle sizes are preferably between approximately 1/1000 and approx. 5/10 mm, in particular between 1/1000 and 1/10 mm.

The particle size is in particular understood to mean the equivalent diameter which then lies in the indicated range. It is also preferred for the typical particle size of the ceramic material to have a largest dimension of 1/1000 to 1 mm, in particular between 1/100 and 5/10 mm.

The thickness of the brake layer is preferably smaller than 1 mm. Specific configurations may show layer thicknesses of up to 2 mm or more.

The brake layer preferably comprises the ceramic or otherwise friction-enhancing material and a carrier material which may be a thermoplastic plastic or an adhesive or an otherwise suitable material.

Preferred specific embodiments provide for the brake layer to contain aluminum oxide particles. Aluminum oxide particles are preferably a substantial component, in particular the main constituent at a percentage of at least 50%, in particular a percentage of at least 80% or 90% of the friction-enhancing particles. These particles offer high hardness, allowing good braking deceleration and a long useful life.

Preferably the brake layer comprises titanium oxide and/or polytetrafluoroethylene and/or molybdenum. It is preferred to use titanium oxide as an additive at a few percent e.g. approximately 3% in the brake layer, in particular in the shape of particles. Titanium oxide is positive since it increases heat dissipation. To increase the lubricating effect, components such as polytetrafluoroethylene may preferably be contained. Molybdenum has a very high hardness and a high friction coefficient.

Other configurations provide for the brake layer to include glass particles or glass dust particles. It is also conceivable that the brake layer comprises silica sand particles. Glass dust particles in an amorphous form or of silica sand are well suited to specifically enhance friction. It is preferred to use ground domestic or industrial waste glass. Waste glass is inexpensive and available in large quantities. The same holds for silica sand particles. The typical particle size lies in particular within the ranges indicated above.

Preferably the rim body comprises rim holes fitted with separate rim eyelets. These rim eyelets are in particular provided in rims of a thermoplastic matrix material since they are not prone to brittle fractures.

It is also conceivable that the rim body consists at least in part of a fibrous composite material with a thermosetting matrix. A fibrous composite material with a thermosetting matrix offers the advantage that the material is inexpensive.

The wheel according to the invention for a bicycle comprises a hub and a rim wherein said rim comprises a rim body which includes at least a rim base and brake sidewalls. The rim body consists at least in part of a fibrous composite material. The brake sidewalls comprise a brake layer of a friction-enhancing material. The wheel according to the invention is in particular equipped with a rim as described above.

The method for manufacturing a bicycle rim according to the invention comprises the following steps:
Manufacturing a rim body at least in part of a fibrous composite material wherein said rim body comprises at least a rim base and brake sidewalls
coating the brake sidewalls with a brake layer which contains a friction-enhancing material.

The method according to the invention also has considerable advantages. The invention allows to manufacture a durable, reliable and lightweight rim.

For manufacturing the rim body, fibers are in particular used wherein at least part of the fibers are reinforcing fibers and at least part of the fibers are of a thermoplastic material.

Preferably at least the following process steps are carried out:
placing the fibers in a mold,
heating the fibers,
cooling the body.

Preferably the rim body is manufactured of a thermoplastic matrix material.

For manufacturing the rim at least two different fiber types are employed namely, a first fiber type of a thermoplastic material and a second type of reinforcing fibers.

It is also preferred that at least some fibers are combination fibers consisting of both at least a reinforcing fiber and a thermoplastic material.

Preferably at least two different fiber types are employed or combination fibers are employed consisting of a core and a sheath. In this case the core may consist of at least a reinforcing fiber, and the sheath of a thermoplastic material. This allows to simplify manufacture since the matrix material and the reinforcing fibers can be applied concurrently.

In all cases it is preferred to employ fibers joined to one another. The fibers used are preferably interconnected by means of a process selected from a group of processes including machine knitting, weaving, knotting, knitting, braiding, and spinning. It is also preferred to employ prefabricated prepregs, tissues, hoses, mats and/or sections.

For manufacturing a rim body, a mold is used which is heated after the fibrous composite material is inserted. Heating occurs in particular in a stove. Heating occurs preferably at a temperature of at least 150° C., in particular at least 170° C., preferably at least 200° C. or 220° C. The exact temperature depends on the specific conditions and may in particular be higher. It is important not to exceed or reach the melting temperature of the thermoplastic fibers. Preferably heating occurs at least over a period of 2 minutes, in particular over a period of 5 to 30 minutes. Subsequent cooling is preferably carried out by spraying with a liquid or dipping into a liquid. Rapid cooling is thus achieved.

For manufacturing, a core may be wrapped which is then placed in a mold. The core is preferably flexible and expands in the mold as the mold is heated. The core may be removed after heating or remain in the rim body.

When the rim body has been manufactured the brake layer is applied. For applying the brake layer the rim body is preferably heated. This may be carried out in one continuous process with manufacturing the actual rim body. The rim body will be cooled down to a temperature suitable for obtaining a permanent shape. The brake sidewall may be reheated if required to plasticize the brake sidewall such that the brake layer material will adhere as it is applied.

It is also conceivable to place on the brake sidewall a separate ring containing the friction-enhancing material and to weld or glue said ring to the rim by locally heating the ring up to the melting temperature.

It is also possible to apply the brake layer in a separate step after manufacture is completed and the rim body is entirely cooled. Such a process may be employed in retrofitting existing rims.

It is also possible to apply the brake layer directly when manufacturing the rim body e.g. by depositing particles of the friction-enhancing material in the mold such that said particles are embedded in the brake sidewalls as they are heated.

Preferred specific embodiments of the method according to the invention provide for the rim body to be dry-coated with particles of a friction-enhancing material. In particular pulverized particles may be used. It is conceivable to put the rim body in a container with particles of a friction-enhancing material. The rim body may for example be pushed or dipped into a container with particles.

In the cases indicated the rim body may first be heated, or an adhesive coating is deposited on the brake sidewalls before the rim body is pushed into a container with particles of a friction-enhancing material or dry-coated with particles of a friction-enhancing material. If an adhesive is used this will in particular be a two-component adhesive.

Preferred configurations provide for the friction-enhancing material to be plasticized and in particular fused and then placed on the brake sidewall.

Preferably the friction-enhancing material is heated and fused by means of a plasma jet. It is also possible and preferred to heat the friction-enhancing material by means of an arc and/or a gas flame. The fused material can then be transported by means of a gas stream, in particular an inert gas stream, to the brake sidewall to be deposited there. Before depositing the brake sidewall may be sandblasted to increase roughness and adhesion.

Such depositing methods are gentle since little heat is generated in the rim body.

Preferred configurations provide for the process to be controlled such that first a rim body is manufactured comprising a hollow space having a radially outwardly and a radially inwardly hollow-space wall. The rim body is manufactured such that the radially outwardly hollow-space wall has a diameter matched to the diameter of a tube tire. The rim body is furthermore manufactured such that the radially inwardly hollow-space wall has a diameter matched to the diameter of a wire tire. After manufacturing such a rim body, the outer hollow-space wall is optionally removed.

The method then serves in particular for manufacturing a rim for a wire tire, in particular for bicycles, where for manufacturing the rim body at least the following process steps are carried out:
a) Manufacturing a rim body for wireless tires having a radially outwardly hollow space,
b) removing the outwardly hollow-space wall such that side strips remain to form rim flanges.

Preferably the outwardly wall of the hollow space is removed such that side strips remain to form rim flanges and/or the radially inwardly hollow-space wall may serve as the rim base.

Preferred specific embodiments provide that rim holes are additionally made in the rim body, said rim holes being provided with rim eyelets as reinforcement for said rim holes.

Rim eyelets are preferably placed in the rim holes of the rim body. The rim eyelets are then bordered so as to result in plastic deformation of the eyelet and/or the rim body. It is in particular preferred that the rim eyelets are inserted automatically and mechanically.

Before inserting, the rim eyelets are preferably provided with a coating having a lubricating effect. Such a lubricating coating is in particular metallic and serves to permit the spoke nipple to rotate easily at the high pressures between the spoke nipple and the rim body such that the spoke pre-stress is easily adjustable.

### BRIEF DESCRIPTION OF THE DRAWINGS

Further advantages and embodiments of the present invention follow from the embodiments which will now be explained with reference to the attached drawings.

FIG. 1 is a first embodiment of a rim according to the invention as a wire tire rim in a schematic cross-section;

FIG. 2 is a second embodiment of the rim manufactured according to the invention as a tube tire rim in a schematic cross-section;

FIG. 3 is a combination fiber with a central reinforcing fiber and a fiber sheath of a matrix material for manufacturing a bicycle rim according to the invention;

FIG. 4 is a fiber strand of reinforcing and matrix fibers for manufacturing a bicycle component according to the invention; and

FIG. 5 is an embodiment of the rim with rim eyelets.

### DETAILED DESCRIPTION OF THE PREFERRED EMBODIMENTS

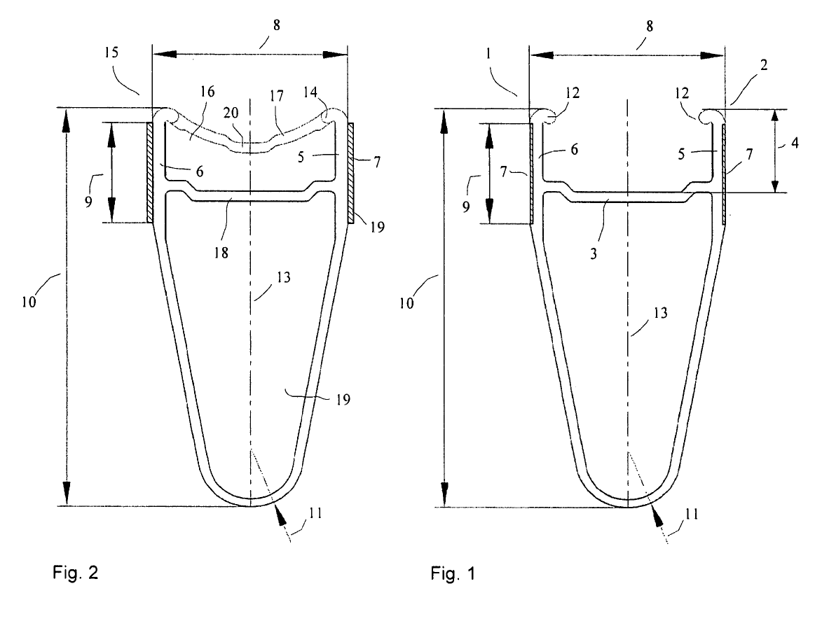

FIG. 1 shows a cross-section of a rim 1 according to the invention for tube tires for bicycles as used in the field of sports and in particular in racing. The rim 1 comprises a rim body 2 with a rim base 3 and lateral brake sidewalls 5, 6. Said brake sidewalls 5, 6 are provided at the rim flanges 12, each comprising a brake layer 7 which is integrated with the brake sidewalls.

The rim 1 consists entirely of a fibrous composite material which in this case contains a thermoplastic matrix material. The matrix material 12 is e.g. polyamide. One advantage of a thermoplastic matrix material is for example that the rim body can be machined or welded.

This rim 1 is manufactured of prepregs deposited on a core in a mold. Said mold is closed and heated for approximately 5 to 15 minutes, e.g. for 10 minutes such that the thermoplastic matrix material melts and distributes homogeneously while pressure is applied externally. Cooling occurs in particular through quenching with a liquid such as water.

The surfaces of the brake layers 7 on the brake sidewalls 5, 6 of the rim body 2 have embedded in them glass and silica sand particles received and retained in the thermoplastic matrix material. Glass is an amorphous material having no crystal structure. The glass particles may be manufactured from recycled waste glass.

The individual glass and silica sand particles protrude minimally from the surface, thus forming a generally rough surface of the brake sidewalls 5, 6. The individual particles are considerably harder than the fibrous composite material. During braking the brake pad is in contact with the brake layers 7. The embedded particles considerably increase friction. Another advantage is that the braking deceleration is less dependent from the ambient conditions since even in wet conditions there will be sufficient friction.

In the embodiment the height 10 of the rim is 40 mm while the height 9 of the sides 5, 6 serving as brake sidewalls is approximately 10 mm. The width 8 of the entire rim in this case is approximately 20 mm and the radius 11, approximately 6 mm. It is pointed out though that other dimensions are also possible. For example the height 10 may be 33 mm while the width is also approximately 20 mm. Higher and lower values are also possible.

In the embodiment according to FIG. 1 firstly the rim body 2 was manufactured of the fibrous composite material. Thereafter, in the preferred process control carried out herein, the rim body 2 is reheated and the glass and silica sand particles deposited on or embedded in the brake sidewalls. To this end the brake sidewalls surfaces are locally plasticized. Alternatively it is conceivable that a separate ring 19 or the like with the brake layer 7 is glued, welded or otherwise affixed to the outside of the rim.

It is also conceivable to manufacture the brake layers 7 directly with manufacturing the rim body 2 by placing the glass and silica sand particles in the mold.

The rim 15 for tube tires illustrated in FIG. 2 comprises a hollow space 16 which is limited on the radially outwardly side by an outwardly wall 17 which serves as a rim base here. Furthermore the hollow space 16 is enclosed by brake sidewalls 5 and 6 toward the sides and radially inwardly, by the inner rim wall 18. Another annular hollow space 19 extends further radially inwardly with sidewalls tapering radially inwardly and ultimately converging, passing into a radius 11.

The outer wall 17 of the hollow space 16 is generally concaved i.e. in the region of the center plane 13 the outer diameter of the rim base is smaller or even the smallest while toward the lateral brake sidewalls 5, 6 it is larger in diameter.

The center region of the tube tire rim 1 is provided with a groove-shaped recess 20 to enable centering and alignment of the tube tire on the rim 15. This reduces the quantity of glue required for gluing on a tube tire (not shown) while enhancing the reliability of the tube tire fit on the rim. The rims 1 and 15 are dimensioned such herein that the two rim bodies may be manufactured from the same basic mold. The rim 1 can be manufactured by processing the rim 15 from FIG. 2.

To convert the rim 15 for tube tires into a rim 1 for wire tires the outwardly wall of the hollow space 16, which is the rim base 17 of the rim 15, is removed, preferably by milling, up to line 14 in the illustration of FIG. 2.

The flanges 5, 6 thus form the rim flanges 5, 6, the ends 12 of which project laterally inwardly to safely and reliably retain the wire tires on the rim 1 by the projection.

To ensure suitability for conversion the distance 4 from the upper edge of the rim base 7 to the upper edge of the rim flanges 5, 6 or to the outwardly wall 17 is adjusted such that if the wall 17 is present it serves as the rim base for tube tires, while with the wall 17 milled out, the inwardly wall 3 serves as the rim base.

In the embodiment according to FIG. 2 the brake layers 7 are deposited separately on the brake sidewalls 5, 6 after manufacturing the actual rim body 2. This is carried out herein by a plasma jet which fuses the ceramic material to be deposited in gentle conditions. It is then deposited on the brake sidewall by a gas, e.g. an inert gas. Ceramic layers excel in their superior hardness.

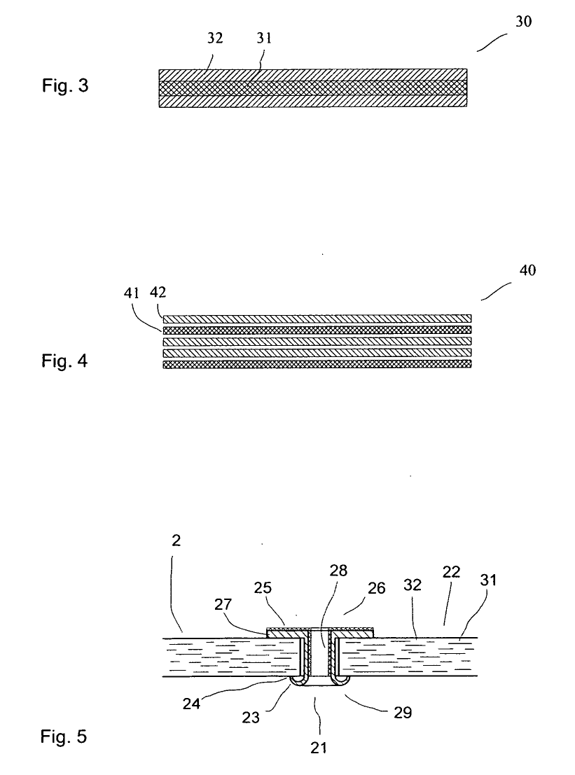

FIG. 3 shows a longitudinal section of a combination fiber 30 as it is preferably used for manufacturing the rim 1, 15 according to the invention. The combination fiber 30 in this embodiment comprises an inner core fiber as a reinforcing fiber 31 and an outer sheath coating 32 consisting of a thermoplastic material.

The method according to the invention uses e.g. combination fibers 30. To manufacture the rim 1 shown in FIG. 1, a combination fiber 30 may be wound around a bobbin core. The wrapped bobbin core is then placed in a mold which is closed. After heating the mold for approximately 5 to 10 minutes (or as short as 3 minutes or 15 minutes, depending on material, wall thickness, etc.) to in this case approximately 220° C., the outer sheath coating 32 liquefies and fuses together such that a matrix coat is formed in which the reinforcing fibers 31 configured as carbon fibers or glass fibers are embedded. The entire mold is quenched in a dip tank for approximately 2 to 3 minutes until the temperature has dropped far enough for the mold to be opened and the rim to be removed.

The same method may be applied with the fibers 40 placed in parallel and illustrated schematically in FIG. 4 wherein in addition to reinforcing fibers 41, thermoplastic fibers 42 or matrix fibers are used.

It is also possible to use a fiber strand (not shown) comprising e.g. a plurality of thermoplastic fibers and a plurality of reinforcing fibers. To retain the individual fibers in the strand, an external structure may be provided that is configured e.g. net-like and may consist of a range of different materials.

The fiber strand may, like the combination fiber 30 or the parallel fibers 40, be used for the manufacture of bicycle rims. To facilitate manufacturing, in particular prefabricated cords and in particular woven mats are used which may comprise combination fibers 30, parallel fibers 40 or fiber strands.

To manufacture the rim 1, woven mats may also be used. After placing the woven mats in the mold, the mold is closed and heated to a temperature above the melting temperature of the thermoplastic material. The thermoplastic fiber portions fuse together, forming the matrix. After cooling the mold e.g. by dipping or sprinkling with water, the component can be removed.

A bobbin core may be used in manufacturing, consisting e.g. of a foam material to remain permanently in the rim 15. The projecting ends may be layered to overlap, forming the rim base 17 of the rim 1 for tube tires. After milling out if required and corresponding shaping, the remainders of the ends form the rim flanges 5, 6 of the rim 1 for wire tires.

Manufacturing may include the use of prepregs placed on a bobbin core. Prepregs may consist of thermosetting fibrous composite materials or else of thermoplastic fibers and of reinforcing fibers.

In all of the cases a pressure may be applied to the fibers or the cloth in the mold.

As is illustrated in FIG. 5, rim eyelets 26 may be affixed to the rim holes 21. After manufacturing the rim body 2 and after cooling the mold, the rim is removed and the rim holes 21 are automatically made by a machine.

Each rim hole 21 is automatically provided with a rim eyelet 26 which is mechanically inserted into the rim hole and then bordered by means of pressure applied to both ends of the rim eyelet so as to obtain a frictional and form-fitting connection. At the local contact areas 24 of the rim eyelets 26 with the rim body 2, the rim base 22 is plastically deformed. The pressure applied to the rim eyelet 26 generates the bordering 23 at the eyelet base 29.

The eyelet head 27 lies flat against the radially outwardly face of the rim base 22 while the eyelet hollow 28 extends through the rim base 22. All or part of the eyelet base 29 contacts the radially inwardly face of the rim base 22.

As is illustrated schematically in FIG. 5, the rim eyelet 26 may comprise an additional coating 25 of a non-volatile material to achieve a lubricating effect. The lubricating coating 25 results in improved rotating of the spoke nipples relative to the rim eyelets such that the desired spoke pre-stress is better adjustable.

1. A bicycle rim, comprising:
a rim body which includes at least a rim base and brake sidewalls;
wherein the rim body consists at least in part of a fibrous composite material; and
wherein the brake sidewalls comprise a brake layer of a friction-enhancing material.

2. The bicycle rim according to claim 1, wherein the rim body consists at least in part of a fibrous composite material with a thermoplastic matrix.

3. The bicycle rim according to claim 1, wherein the brake layer comprises particles of the friction-enhancing material.

4. The bicycle rim according to claim 1, wherein the friction-enhancing material comprises a ceramic material.

5. The bicycle rim according to claim 3, wherein the typical particle size is between 1/1000 and 5/10 mm, in particular between 1/1000 and 1/10 mm.

6. The bicycle rim according to claim 1, wherein the layer thickness of the brake layer is smaller than 1 mm.

7. The bicycle rim according to claim 3, wherein the brake layer comprises aluminum oxide particles.

8. The bicycle rim according to claim 1, wherein the brake layer comprises titanium oxide and/or polytetrafluoroethylene and/or molybdenum.

9. The bicycle rim according to claim 3, wherein the brake layer comprises glass dust particles.

10. The bicycle rim according to claim 3, wherein the brake layer comprises silica glass particles.

11. The bicycle rim according to claim 1, wherein the rim body comprises rim holes which are provided with separate rim eyelets.

12. The bicycle rim according to claim 1, wherein the rim body consists at least in part of a fibrous composite material with a thermosetting matrix.

13. A wheel for a bicycle comprising: a hub and a rim; wherein said rim comprises a rim body which includes a rim base; and brake sidewalls;
wherein the rim body consists at least in part of a fibrous composite material; and
wherein the brake sidewalls comprise a brake layer of a friction-enhancing material.

14. A method for manufacturing a bicycle rim comprising the following steps:
manufacturing a rim body at least in part of a fibrous composite material, wherein said rim body comprises a rim base and brake sidewalls (5, 6); and
coating the brake sidewalls with a brake layer which includes a friction-enhancing material.

15. The method according to claim 14 wherein for manufacturing the rim body, fibers are used wherein at least part of said fibers consists of reinforcing fibers and at least part of said fibers consists of a thermoplastic material, and wherein at least the following process steps are carried out:
placing the fibers in a mold,
heating the fibers,
cooling the body.

16. The method according to claim 1, wherein for manufacturing the rim body at least two different fiber types are used namely, a first fiber type of a thermoplastic material and a second type of reinforcing fibers.

17. The method according to claim 14, wherein at least some fibers are combination fibers consisting of both at least one reinforcing fiber and a thermoplastic material.

18. The method according to claim 14, wherein fibers interconnected with one another are used.

19. The method according to claim 14, wherein the rim body is heated for depositing the brake layer.

20. The method according to claim 14, wherein the rim body is dry-coated with particles of a friction-enhancing material.

21. The method according to claim 14, wherein the rim body is put in a container with particles of a friction-enhancing material.

22. The method according to claim 14, wherein the brake sidewalls are provided with an adhesive coating.

23. The method according to claim 14, wherein the friction-enhancing material is fused and deposited on the brake sidewall.

24. The method according to claim 23, wherein the friction-enhancing material is heated by means of a plasma jet, an arc and/or a gas flame.

25. The method according to claim 14, wherein firstly the rim body is manufactured which comprises a hollow space with a radially outwardly and a radially inwardly hollow-space wall,
wherein the rim body is manufactured such that the radially outwardly hollow-space wall has a diameter matched to the diameter of a tube tire, and
wherein the rim body is manufactured such that the radially inwardly hollow-space wall has a diameter matched to the diameter of a wire tire, and
wherein the outwardly wall of the hollow space is removed after manufacture of the rim body.

26. The method according to claim 14, wherein rim holes are additionally made in the rim body, and the rim holes are provided with rim eyelets as reinforcement for the rim holes.

27. The method according to claim 14, wherein the rim eyelet is provided with a coating having a lubricating effect.
